(19) United States
(12) Patent Application Publication
(10) Pub. No.: US 2010/0002910 A1
(43) Pub. Date: Jan. 7, 2010

(54) Method and Apparatus for Developing Synthetic Three-Dimensional Models from Imagery

(75) Inventors: Walter H. Delashmit, JR., Justin, TX (US); James T. Jack, JR., Arlington, TX (US)

Correspondence Address: WILLIAMS, MORGAN & AMERSON, 10333 RICHMOND, SUITE 1100, HOUSTON, TX, 77042, US

(73) Assignee: Lockheed Martin Corporation

(21) Appl. No.: 12/559,771

(22) Filed: Sep. 15, 2009

Related U.S. Application Data
(63) Continuation of application No. 10/758,452, filed on Jan. 15, 2004, now abandoned.

(51) Int. Cl. G06K 9/00; G06T 15/00; G06K 9/36

(52) U.S. Cl. 382/103; 345/419; 382/285

(57) ABSTRACT

A method and apparatus for modeling an object in software are disclosed. The method includes generating a three-dimensional geometry of the object from a plurality of points obtained from a plurality of images of the object, the images having been acquired from a plurality of perspectives; and generating a three-dimensional model from the three-dimensional geometry for integration into an object recognition system. The apparatus may be a program storage medium encoded with instructions that, when executed by a computer, perform such a method or a computer programmed to perform such a method.

### BACKGROUND OF THE INVENTION

1. Field of the Invention

The present invention pertains to software modeling of objects, and, more particularly, to a method and apparatus for developing synthetic three-dimensional models from imagery.

2. Description of the Related Art

One valuable use for automated technologies is “object recognition.” Many diverse fields of endeavor value the ability to automatically, accurately, and quickly view and classify objects. For instance, many industrial applications sort relatively large numbers of parts, which may be an expensive, time-consuming task if performed manually. As another example, many military applications employ autonomous weapons systems that need to be able to identify an object as friend or foe and, if foe, whether it is a target.

Although there are many approaches, some general characterizations can be drawn. Object recognition systems typically remotely sense one or more characteristics of an object and then classify the object by comparing the sensed characteristics to some stored profile of the object. Frequently, one of these characteristics is the shape, or geometry, of the object. Such an object recognition system remotely senses the object's geometry and then compares it to one or more stored geometries for one or more reference objects. If one of the reference objects matches, then the object is classed accordingly.

In a geometry-matching type of approach, the model may be developed in a variety of ways. The model may be developed by actually remotely sensing the geometry of an exemplary object in a controlled setting. More typically, the model is developed in a two step process. The first step is to measure the geometry of an exemplary object. The second step is to emulate the patterns of received radiation that would be received from the measured geometry should the exemplary object actually be remotely sensed. For instance, if the remote sensing technology is a laser radar, or “LADAR” system, this second step applies a “ray tracing” package to the measured geometry. The ray tracing package is a software-implemented tool that emulates remotely sensing the exemplary object by calculating the patterns of the returns that would be received if the exemplary object were actually remotely sensed.

In many of these applications, the quick efficient development of accurate models is an important consideration. Consider an automatic target recognition system (“ATR System”) employed in a military environment. An automated weapon system might need to be able to sense and identify numerous types of vehicles in a theater of operation. Many of these vehicles may be of the same type, e.g., tanks, armored personnel carriers, truck, etc. whose function dictate their form and result in similar geometries. In the era of coalitions, many countries might have vehicles in relatively close proximity, so there may be many different variations of the same type of vehicle. Accurate identification is very important as vehicles are frequently destroyed and lives lost based on the determination. Still further, as new parties join the conflict, or as new weapons systems are introduced, the ATR system must be quickly updated with the needed model(s).

Object recognition systems used in military applications suffer from another difficulty—namely, it can be very difficult to obtain an exemplary object from which to develop the three-dimensional model. Allies might provide an exemplary object quite willingly just for this very purpose to, for instance, try and prevent friendly fire incidents. Potential foes and nominal enemies, however, are not likely to be willing at all. Actual enemies would not consider it. Even if an exemplary object can be captured from an actual enemy by force of arms, a significant logistical effort would be required to move it to the controlled environment.

Consider, for example, the capture of a new enemy tank. Tanks are ordinarily very large and heavy, making them difficult to move and conceal. The controlled environment will typically be several tens of miles away from the capture sight, and sometime as many as hundreds of miles away. Thus, the tank must be transported a long distance, with little or no concealment, while avoiding hostile and friendly fire. Not only would such a feat be difficult to achieve, but it would also take considerable time.

The present invention is directed to resolving, or at least reducing, one or all of the problems mentioned above.

### SUMMARY OF THE INVENTION

The invention, in its various aspects and embodiments, includes a method and apparatus for modeling an object in software. The method comprises generating a three-dimensional geometry of the object from a plurality of points obtained from a plurality of images of the object, the images having been acquired from a plurality of perspectives; and generating a three-dimensional model from the three-dimensional geometry for integration into an object recognition system. The apparatus may be a program storage medium encoded with instructions that, when executed by a computer, perform such a method or a computer programmed to perform such a method.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a method for modeling an object in three dimensions in software in accordance with the present invention;

FIG. 2 depicts, in a block diagram, selected portions of a computing apparatus with which certain aspects of the present invention may be implemented;

FIG. 3 depicts a set of source images of an object stored in a data structure and presented to the user on the display of the computing apparatus in FIG. 2;

FIG. 4 illustrates a two-part process for creating a 3D geometry of the object from the source images of FIG. 3;

FIG. 5 illustrates one implementation for the generation of a preliminary 3D geometry in the process of FIG. 4;

FIG. 6 depicts the presentation of the source images of FIG. 2 with a plurality of points user-selected used in defining the 3D object geometry;

FIG. 7 conceptually illustrates the calibration of the source images of FIG. 3 and the mapping of the selected points shown in FIG. 6 into a 3D space;

FIG. 8 is a screen shot of selected points in four views that have been mapped into the 3D space to define the object geometry;

FIG. 9 is a screen shot of a part of the process of defining surface geometries from the selected points;

FIG. 10 is a screen shot of the result of defining surface geometries from the selected points as applied to the four views in FIG. 8;

FIG. 11 is a visual presentation of the 3D geometry after additional, optional processing to impart effects such as texturing;

FIG. 12 illustrates a two-part process for generating a synthetic 3D model from the 3D geometry;

FIG. 13 illustrates the role of the software application first shown in FIG. 2 in the illustrated embodiment of the present invention;

FIG. 14 depicts a system diagram of an imaging system implementing the present invention in a field environment;

FIG. 15 depicts one particular embodiment of the system in FIG. 4 constructed and operated in accordance with the present invention to acquire data about a field of view through an optics package aboard a platform shown therein;

FIG. 16 depicts a LADAR data set acquired by the platform in the embodiment of FIG. 14; and

FIG. 17 depicts the handling of three-dimensional data acquired in the scenario in FIG. 14 and FIG. 16 as employed in an automatic target recognition system.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

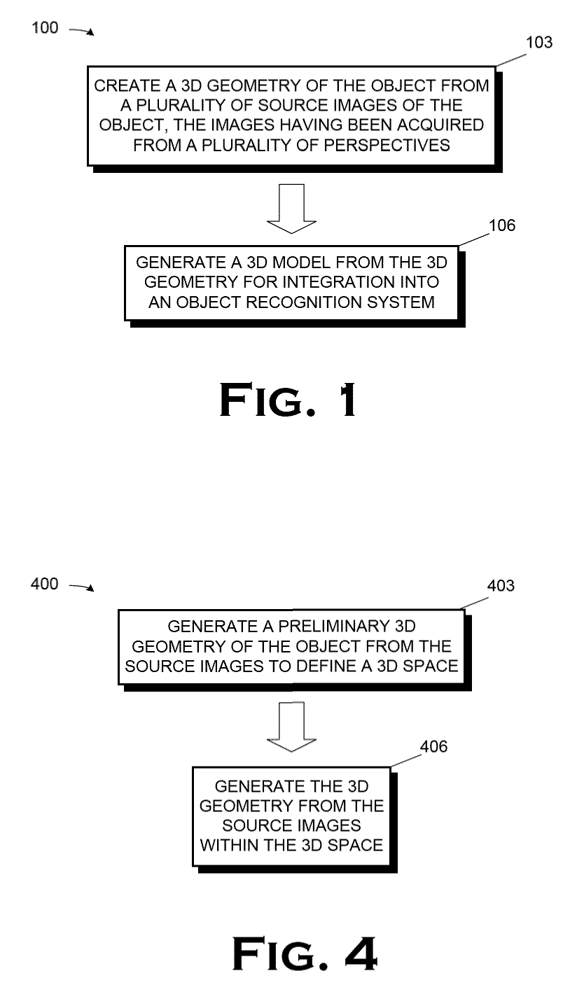

Turning now to the drawings, FIG. 1 illustrates a method 100 for modeling an object in software in accordance with the present invention. The method 100 comprises first creating (at 103) a three-dimensional (“3D”) geometry of the object from a plurality of source images of the object, the images having been acquired from a plurality of perspectives. Next, the method 100 generates (at 106) a synthetic 3D model from the three-dimensional geometry for integration into an object recognition system. The 3D model is “synthetic” in that it is not developed from the object itself, but rather some representation of that object.

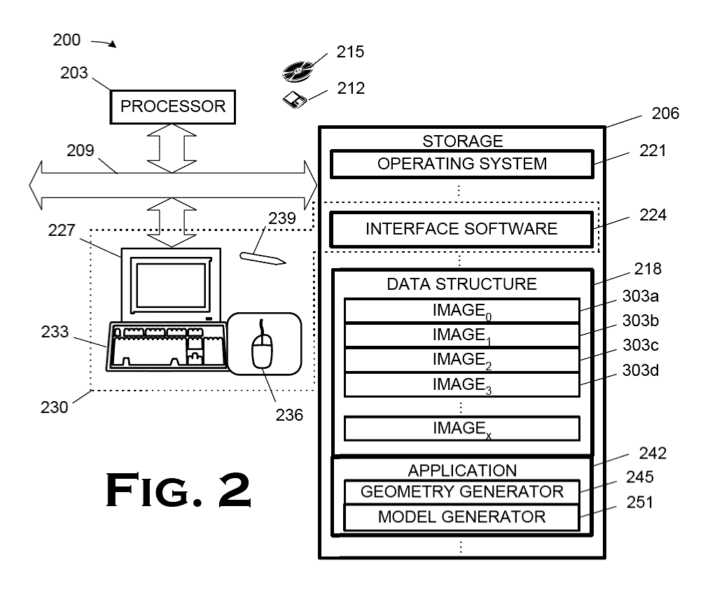

The method 100 is largely software implemented on a computing apparatus, such as the computing apparatus 200 illustrated in FIG. 2. FIG. 2 depicts, in a block diagram, selected portions of the computing apparatus 200, including a processor 203 communicating with storage 206 over a bus system 209. In general, the computing apparatus 200 will handle a fair amount of data, and some of it will be graphics, which is relatively voluminous by nature. Thus, certain types of processors are more desirable than others for implementing the processor 205. For instance, a digital signal processor (“DSP”) or graphics processor may be more desirable for the illustrated embodiment than will be a general purpose microprocessor. Other video handling capabilities might also be desirable. For instance, a Joint Photographic Experts Group (“JPEG”) or other video compression capability and/or multi-media extension may be desirable. In some embodiments, the processor 205 may be implemented as a processor set, such as a microprocessor with a graphics co-processor.

The storage 206 may be implemented in conventional fashion and may include a variety of types of storage, such as a hard disk and/or RAM and/or removable storage such as the magnetic disk 212 and the optical disk 215. The storage 206 will typically involve both read-only and writable memory implemented in disk storage and/or cache. Parts of the storage 206 will typically be implemented in magnetic media (e.g., magnetic tape or magnetic disk) while other parts may be implemented in optical media (e.g., optical disk). The present invention admits wide latitude in implementation of the storage 206 in various embodiments.

The storage 206 is encoded with one or more data structures 218 employed in the present invention as discussed more fully below. The storage 206 is also encoded with an operating system 221 and some interface software 224 that, in conjunction with the display 227, constitute an operator interface 230. The display 227 may be a touch screen allowing the operator to input directly into the computing apparatus 200. However, the operator interface 230 may include peripheral I/O devices such as the keyboard 233, the mouse 236, or the stylus 239. The processor 203 runs under the control of the operating system 221, which may be practically any operating system known to the art. The processor 203, under the control of the operating system 221, invokes the interface software 224 on startup so that the operator (not shown) can control the computing apparatus 200.

However, the storage 206 is also encoded with an application 242 in accordance with the present invention. The application 242 is invoked by the processor 203 under the control of the operating system 221 or by the user through the operator interface 230. The user interacts with the application 242 through the user interface 230 to input information on which the application 242 acts to generate the synthetic 3D model. An exemplary implementation will now be discussed to further an understanding of the invention.

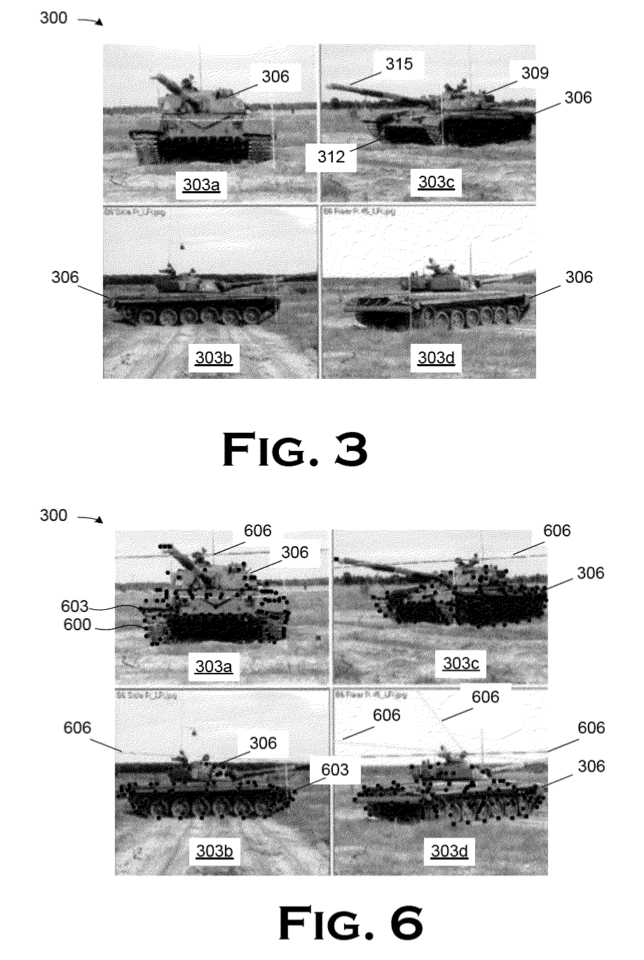

FIG. 3 depicts a set 300 of four source images 303a-303d of an object 306. The source images 303a-303d are stored in the data structure 218 and presented to the user on the display 227, both shown in FIG. 2. In the illustrated embodiment, the object 306 is a tank, although practically any other object may be the subject. The object 306 need not be a vehicle or have a military application in alternative embodiments. Similarly, the number of source images is not material to the practice of the invention, so long as there are multiple images, and other embodiments may use more or fewer images. As a general rule, more complex objects will benefit from having a higher number of photographs. The source images 303a-303d also need not be presented simultaneously, as shown in FIG. 3, although that may be advantageous in some embodiments.

The source images 303a-303d are photographs, but other types of source images may also be used. Photographs are desirable for a number of reasons, such as easy acquisition, relatively high resolution, and intuitive human perception. However, images from almost any two-dimensional (“2D”) or 3D sensor may be used, including, but not limited to, laser radar (“LADAR”), synthetic aperture radar (“SAR”), photographs, drawings, and infrared. Note that, with some types of imagery, the user may benefit from training in interpreting the images. Other remote sensing technologies may also be used to acquire the source images.

Note that the source images 303a-303d are 2D data sets and, in FIG. 3, are presented in a form perceptible by humans. The source images 303a-303d may be acquired digitally and downloaded as digital files to the computing apparatus 200 or scanned in and stored on the computing apparatus 200. In the illustrated embodiment, the source images 303a-303d were acquired digitally by a camera (not shown) and downloaded as JPEG (i.e., *jpg) files to the computing apparatus 200. Although the illustrated embodiment stores the source images 303a-303d in a JPEG format, virtually any electronic image format may be used. Other suitable file formats for 2D images include, but are not limited to GIF (i.e., *.gif), TIF (i.e., *.tif), PDF (i.e., *.pdf), etc.

The source images 303a-303d are also each taken from a different perspective. The source images 303a-303d are, respectively, a front, plan view; a right, side, plan view; a front, right, quarter view, and a right, hind, quarter view. Quartering views are generally more desirable than other views but are not required. Note that the source images 303a-303d are all acquired from approximately the same elevation. This is not required for the practice of the invention. Differing elevations may even be desirable in some implementation to better capture certain aspects of the object's geometry. Note also that there is no requirement that an image encompass the entire object. In fact, with highly complex objects, separate images of intricate parts may be used to achieve higher fidelity. These separate images, in order to convey the additional detail, may sometimes need to exclude even large portions of the object.

If the object articulates, a video or other detailed description of the operation may be useful to improve the fidelity of the model. For instance, the object 306 in FIG. 3 is a tank. The turret 309 moves relative to the body 312 and the cannon 315, all of which are designated only in the image 303c, articulates relative to the turret 309, and, hence to the body 312. In some embodiments, the tank may be modeled as a single, whole object. However, these embodiments will lose some fidelity in the resultant model because the model will not be able model the movements of the turret 309, body 312, and cannon 315 relative to one another. Other embodiments, however, may model the turret 309, body 312, and cannon 315 separately such that the resultant model actually comprises three sub-models.

Once, the source images 303a-303d have been acquired and presented to the user, the method 100, illustrated in FIG. 1, is begun. As noted above, the method 100 begins by first creating (at 103) a 3D geometry of the object 306 from the source images 303a-303d of the object. In the illustrated embodiment, this is performed in a two step process 400, illustrated in FIG. 4, in which a preliminary geometry is constructed (at 403) to define a 3D space which is followed by developing (at 406) a final geometry in that 3D space.

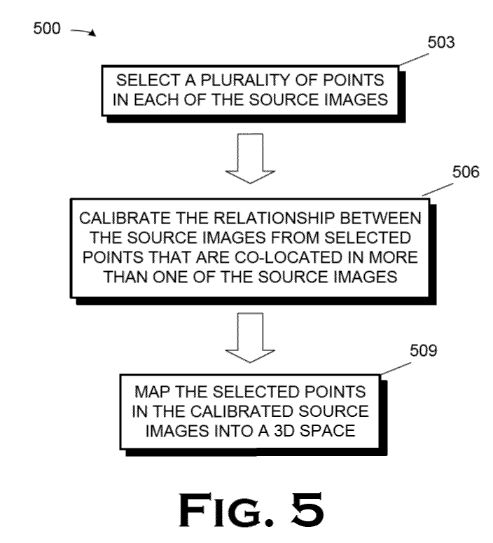

FIG. 5 illustrates one implementation 500 for the generation (at 403, in FIG. 4) of the preliminary geometry in the present invention. The generation begins by selecting (at 503) a plurality of points in each of the source images. The relationship(s) between/among the images is/are calibrated (at 506) from selected points that are co-located in more than one of the two-dimensional images. The selected points in the calibrated two-dimensional images are then mapped (at 509) into a three-dimensional space.

FIG. 6 depicts the presentation 300 of the four source images 303a-303d in which a plurality of points 600 (only one designated) are selected (at 503, FIG. 5). The manner in which the points 600 are selected will be implementation specific. For instance, if the user interface 230, shown in FIG. 2, is a graphical user interface, the user may select individual points 600 by positioning a cursor (not shown) with the mouse 236. Alternatively, if the display 227 includes a touch-screen, the user can select individual points 600 using, for example, the stylus 239, or even their finger.

The implementation 500 then calibrates (at 506) between the source images 303a-303d from the selected points 600 that are co-located in more than one of the source images 303a-303d. Some of the points 600 will be “co-located” in more than one of the source images 303a-303d. For instance, the point 603 can be designated in both source images 303a and 303b. At least some of the points 600 are co-located in this manner across two or more of the source images 303a-303d. Depending on the implementation, 9 to 20 co-located points should suffice. The co-located points are used to calibrate the source images 303a-303d as described below. At this point in the illustrated embodiment, a preliminary geometry is being constructed to define a 3D space. Some embodiments may therefore designate only co-located points (e.g., the co-located point 603) at this point in the process. However, this is not necessary to the practice of the invention, and is not the case in the illustrated embodiment.

Although not shown in FIG. 5, the illustrated embodiment also includes a verification of the co-located points among the source images 303a-303d after the point designations (at 503) and the calibration (at 506). Verification of the co-located points includes visually inspecting the selected co-located points, e.g., the points 603, for misalignment within their respective source images 303a-303d. Misaligned co-located points can then be properly aligned. Additional co-located points can also be selected at this time to improve the definition of the preliminary geometry.

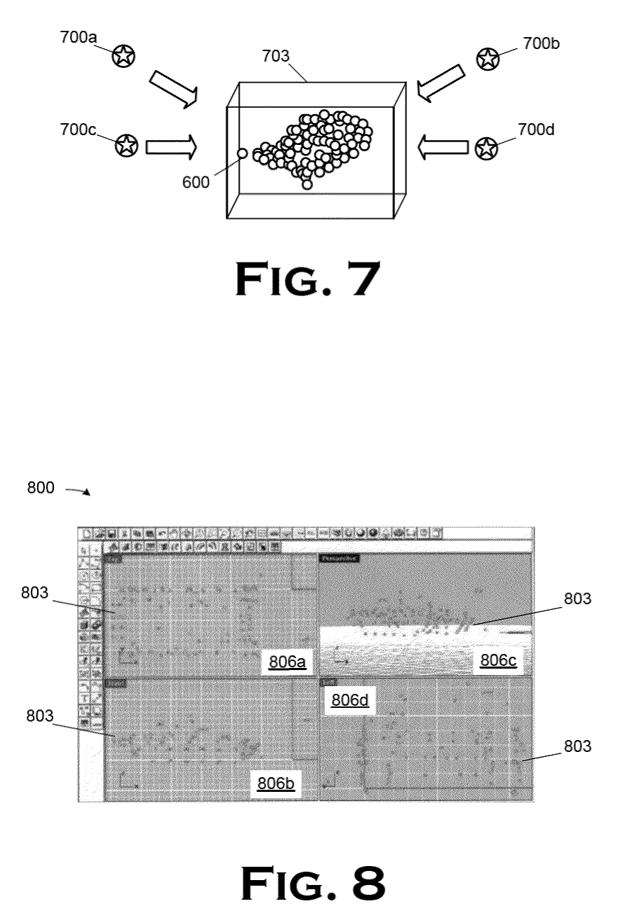

The source images 303a-303d are then calibrated (at 506) from the co-located points. In general, the calibration involves determining selected parameters regarding the acquisition of the source images 303a-303d. These parameters may include, for example, position, rotation, focal length, and distortion. FIG. 7 conceptually illustrates the calibration by showing the sensor positions 700a-700d for the acquisition of the source images 303a-303d and the directional relationship therebetween. Note that which parameters are selected will be, to at least some degree, implementation specific. Focal length, for example, is a parameter related to cameras used for acquisition of photographic imagery and is not relevant to, for instance, LADAR. Sensor position, however, will generally be determined regardless of the type of sensor used in acquisition. FIG. 6 contains several axes 606 through the co-selected points that are artifacts or are resultant of the calibration (at 506).

In some embodiments, the calibration (at 506) may benefit from knowledge regarding the make and model of the sensor used for the acquisition. For instance, the selected parameters may include parameters that can be empirically determined as characteristics of the sensor independent of its application. Such information can be stored in a data structure, such as the data structure 218 in FIG. 2, indexed by, for example, the make and model of the sensor, and then accessed when needed. Such an approach may reduce or simplify the computational demands on the computing system 200 and, in some circumstance, impart higher accuracy. Depending on the implementation, the information identifying the sensor can be input with the source images 303a-303d through the user interface 230.

The implementation 500 then maps (at 509) the selected points 600 in the calibrated source images 303a-303d into a 3D space, e.g., the 3D space 703 in FIG. 7. This step is conceptualized in FIG. 7, in which the selected points 600 (only one designated) are shown conceptually mapped into a 3D space 703. The illustrated embodiment first defines the 3D space 703 from the calibrated relationships of the source images 303a-303d determined as described above. The selected points 600 are then mapped into the 3D space 703 from the positions of the co-located points.

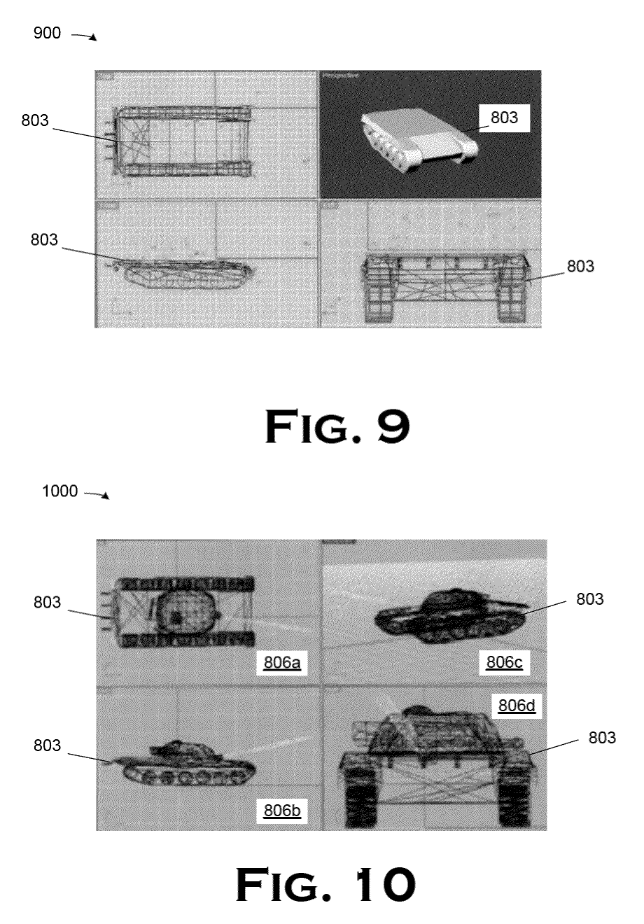

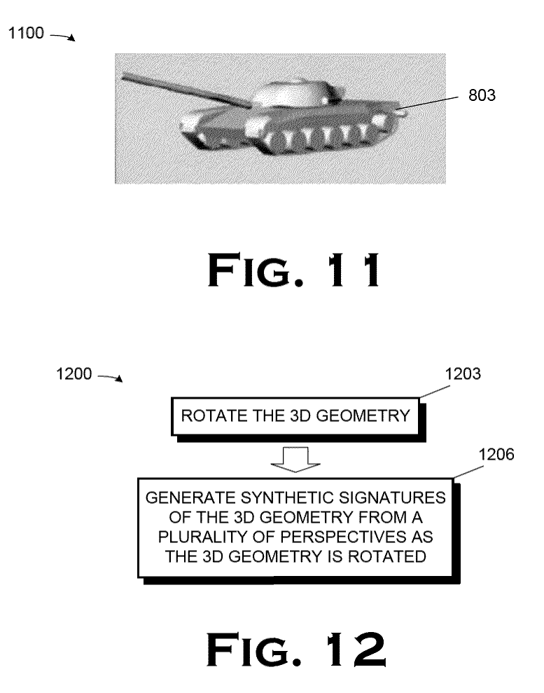

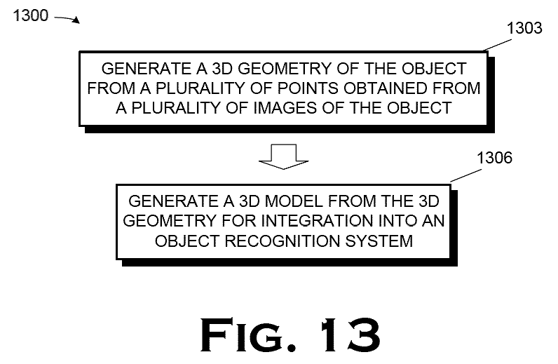

Rough object geometries can then be constructed from the mapped points using standard polygon-based techniques. FIG. 8 is a screen shot 800 of selected points 600 that have been mapped into the 3D space 703 to define the final object geometry 803. More particularly, the screenshot 800 presents four views 806a-806d of the geometry 803. The collection of the rough object geometries defines a preliminary object geometry. The preliminary object geometry, as a result of the process described above, defines a 3D space into which a final object geometry may be created. In general, constructing the rough object geometries includes generating a plurality of surface geometries from 3D data by, for example, connecting the mapped, 3D data to planar curves (not shown). FIG. 9 is a screen shot 900 of a part of this process, and FIG. 10 is a screen shot 1000 of the result as applied to the four views 806a-806d in FIG. 8. FIG. 1t is a visual presentation of the 3D geometry 806 after additional processing not necessary to the practice of the invention has included effects such as texturing.

Once the surface geometries are generated, the final object geometry is scaled into real world coordinates. In general, this may be performed by referring to some known dimension in the source images. For instance, one of more of the source images may include a calibration stick (not shown) therein, the calibration stick being of an accurately and precisely known length. The length of the calibration stick in the image can give a measure of the dimensions for the object. The object can then be scaled the proportional amount needed to scale the image of the calibration stick to the true length thereof. Alternative embodiments may, however, use alternative approaches in scaling the final object geometry. For instance, a scale may be derived from other objects within the picture whose dimensions are known. Or, the real-world dimensions may be derived from other sources. For instance, relative to the illustrated embodiment, Jane's Information Group offers a number of publications regarding military vehicles, such as “Armour and Artillery” and “Military Vehicles and Logistics,” that provide such information.

Returning to FIG. 4, the two-step process 400 then generates (at 406) the final 3D geometry from the source images 303a-303b within the 3D space 703. Generating (at 406) the final geometry includes selecting additional points 600, shown in FIG. 6, in the source images 303a-303d as described above and then mapping them into the 3D space 703, also as described above. The additional selected points 600 and their mapping into the 3D space 703 fleshes out the rough geometry previously generated (at 403) to provide higher fidelity to the object 306. Note that, in some embodiments, the creation of the 3D geometry may be performed in a single step, i.e., not broken down into developing a preliminary and a final 3D geometry.

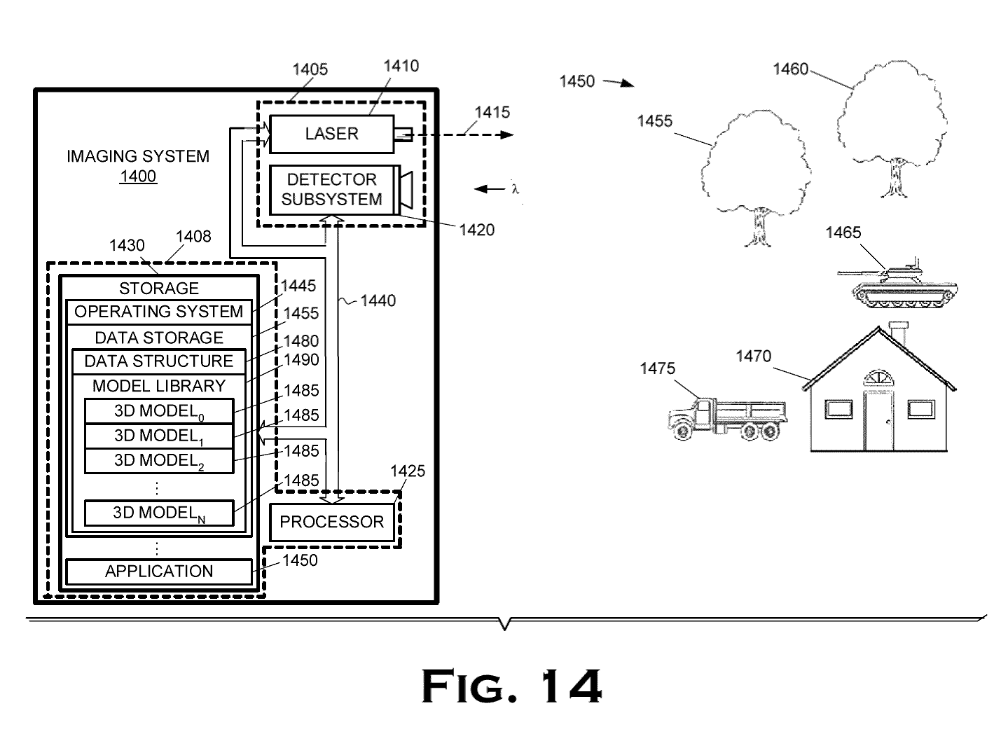

Returning now to FIG. 1, once the 3D geometry is developed (at 103), the method 100 generates (at 106) a synthetic 3D model from the 3D geometry for integration into an object recognition system. FIG. 12 illustrates a two-part process 1200 for generating a synthetic 3D model from the 3D geometry. The process 1200 first rotates (at 1203) the 3D geometry then generates (at 1206) a plurality of synthetic signatures of the synthetic 3D model from a plurality of perspectives as the 3D geometry is rotated. Note that the synthetic 3D model rotation (at 1203) and the synthetic signature generation (at 1206) are performed by the application 242, shown in FIG. 2, autonomously, i.e., without human intervention or interaction.

In general, synthetic signature generation (at 1206) is performed by emulating the acquisition of identifying information as performed in the object recognition system into which the synthetic 3D model will be integrated. The illustrated embodiment develops synthetic 3D models for use in a LADAR-based automatic target recognition (“ATR”) system. Thus, the illustrated embodiment generates a plurality of synthetic LADAR signatures that define the synthetic 3D model. The emulation is performed by a “ray-tracing” package, which emulates the acquisition of LADAR data by the ATR. More particularly, ray tracing packages employ radiosity and global illumination techniques, which are advanced computer graphics techniques that model the physical behavior of light in an environment. They allow accurate calculation of the distribution of light in the environment, and to visualize the environment in full color. Ray-tracing programs capable of performing this kind of emulation are known in the art and are available commercially off-the-shelf.

Thus, in the illustrated embodiment, the application 242, shown in FIG. 2, implements a method 1300, shown in FIG. 13. The application 242 comprises a geometry generator 245 that, as shown in FIG. 13, generates (at 1303) a 3D geometry of the object from a plurality of points obtained from a plurality of images of the object, the images having been acquired from a plurality of perspectives. The application 242 also comprises a model generator 251 that generates (at 1306) a synthetic 3D model from the 3D geometry for integration into an object recognition system.

In one particular embodiment, the geometry generator 245 is implemented in a pair of commercially available, off-the-shelf products. The first product is sold under the mark IMAGEMODELER™ in the United States by:

REALVIZ Corp.

350 Townsend Street, Suite 409

San Francisco, Calif. 94107

USA

Tel: 415-615-9800

Fax: 415-615-9805

Additional contact information is available on their website on the World Wide Web of the Internet. The IMAGEMODELER™ software accepts photographic input, generates a 3D geometry from user input as described above, and exports the 3D geometry for storage in a data structure (e.g., the data structure 218) on the storage 206. The 3D geometry exported by the IMAGEMODELER™ software lacks the surface geometries, however.

The second product in which the geometry generator 245 is implemented is sold under the mark RHINO™ in the United States by:

Robert McNeel & Associates

3670 Woodland Park Ave North

Seattle, Wash. 98103

USA

Tel: 206-545-7000

Fax: 206-545-7321

Additional contact information is available on their website on the World Wide Web of the Internet. The RHINO™ software takes the 3D geometry exported from the IMAGEMODELER™ software and generates the surface geometries as described above. Note that the IMAGEMODELER™ software is capable of generating the surface geometries, but the result is somewhat more difficult to implement in the present invention than is the result exported by the RHINO™ software.

In this same particular embodiment, the model generator 251 is implemented in another software application known to the art as RADIANCE. RADIANCE is a UNIX-based lighting simulation and analysis tool available from Lawrence Berkeley Laboratory (Berkeley, Calif.) at:

Lighting Systems Research

Building 90, Room 3111

Lawrence Berkeley Laboratory

1 Cyclotron Road

Berkeley, Calif. 94720

More particularly, RADIANCE is a suite of programs for the analysis and visualization of lighting in design. The RADIANCE software package includes a routine that converts the geometries output by the RHINO software into the format for RADIANCE input.

RADIANCE input files specify the scene geometry, materials, luminaires, time, date and sky conditions (for daylight calculations). Calculated values include spectral radiance (i.e., luminance+color), irradiance (illuminance+color) and glare indices. Simulation results may be displayed as color images, numerical values and contour plots. Additional contact information is available, and copies may be obtained and licensed, on their website on the World Wide Web of the Internet. Note however, that other ray tracing applications may be used in alternative embodiments. One such alternative package is the Persistence of Vision Ray Tracer, or “POV-Ray” package, also readily available from povray.org over the Internet.

As was noted earlier, in some embodiments, the synthetic 3D model may be developed from 3D source images. In these embodiments, the data input described relative to FIG. 5 and FIG. 6 may be omitted, and the 3D geometry may be generated directly from the 3D source images. These embodiments may also omit the intermediate step of generating a preliminary 3D geometry (at 403, FIG. 4) since the 3D images have already defined the 3D space into which the 3D geometry is generated (at 406). With respect to the particular implementation of the illustrated embodiment described immediately above, the act of inputting the 2D data through the IMAGEMODELER™ software can be omitted. The 3D source images may instead be input directly to the RHINO™ software, whose output would then be input to the RADIANCE software tool.

The synthetic 3D model generated (at 106, in FIG. 1) by the process set forth above can be used in a variety of ways. One use alluded to above is incorporation into an automatic object recognition system. The synthetic 3D model generator can be used, for instance, in visual simulations or in developing algorithms for object recognition systems.

The synthetic 3D model generated (at 106, in FIG. 1) is to be incorporated into an object recognition system. Thus, the synthetic 3D model is to be generated from the 3D geometry with an eye to the requirements of the object recognition system. As previously mentioned, the illustrated embodiment incorporates the synthetic 3D model into a LADAR-based ATR system. The synthetic 3D model reflects this in its makeup of synthetic LADAR signatures generated for a LADAR emulating ray tracing package. Note that, in the illustrated embodiment, the input data (i.e., the source images 303a-303d) are acquired using a remote sensing technology different from that employed by the object recognition system. However, in some cases, it may be the same. For instance, the input data may be 3D LADAR images in some alternative embodiments.

To further an understanding of the present invention and its use, and in particular to elucidate what the synthetic LADAR signature strives to emulate and how the synthetic 3D model is used, a brief description of the LADAR data acquisition for the ATR shall now be presented. FIG. 14 illustrates an imaging system 1400 constructed and operated in accordance with the present invention in a field environment. The imaging system 1400 comprises a data acquisition subsystem 1405 and a data processing subsystem 1408. In the illustrated embodiment, the data acquisition subsystem 1405 includes a laser 1410 that produces a laser beam 1415 and a detector subsystem 1420. The data processing subsystem 1408 includes a processor 1425, and an electronic storage 1430 communicating via a bus system 1440. In the illustrated embodiment, the processor 1425 controls the operation of both the data acquisition subsystem 1405 and the data processing subsystem 1408. However, the data acquisition subsystem 1405 and the data processing subsystem 1408 may be under separate control in alternative embodiments.

In general, the elements of the imaging system 1400 may be implemented in any suitable manner known to the art. The processor 1425 may be any kind of processor, such as, but not limited to, a controller, a digital signal processor (“DSP”), or a multi-purpose microprocessor. The electronic storage 1430 may include both magnetic (e.g., some type of random access memory, or “RAM”, device) and optical technologies in some embodiments. The bus system 1440 may employ any suitable protocol known to the art to transmit signals. Particular implementations of the laser 1410, laser beam 1415, and detector subsystem 1420 are discussed further below.

The processor 1425 controls the laser 1410 over the bus system 1425 and processes data collected by the detector subsystem 1420 from an exemplary scene 1450 of an outdoor area. The illustrated scene includes trees 1455 and 1460, a military tank 1465, a building 1470, and a truck 1475. The tree 1455, tank 1465, and building 1470 are located at varying distances from the system 1400. Note, however, that the scene 1450 may have any composition. One application of the imaging system 1400, as shown in FIG. 14, is to detect the presence of the tank 1465 within the scene 1450 and identify the tank 1465. The processor 1425 operates under the direction of the operating system 1445 and application 1450 to fire the laser 1410 and process data collected by the detector subsystem 1420 and stored in the data storage 1455 in a manner more fully described below.

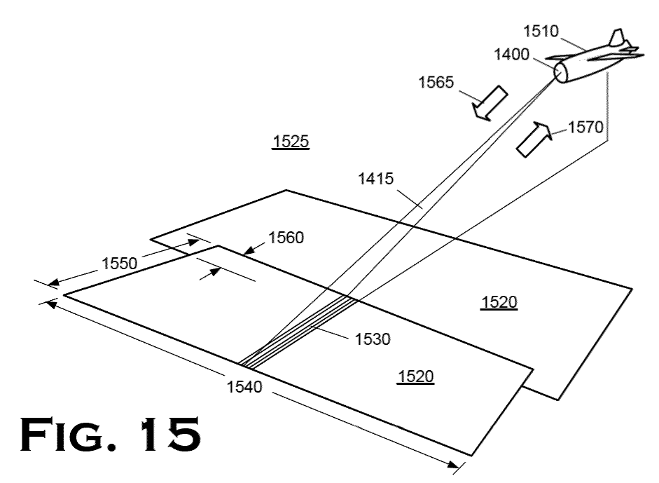

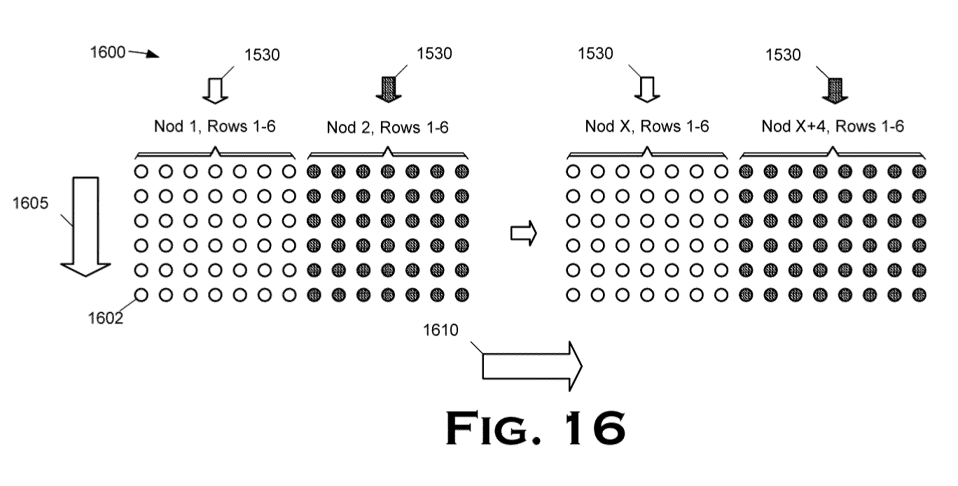

The imaging system 1400 produces a LADAR image of the scene 1450 by detecting the reflected laser energy to produce a three-dimensional image data set in which each pixel of the image has both z (range) and intensity data as well as x (horizontal) and y (vertical) coordinates. The operation of the imaging system 1400 is conceptually illustrated in FIG. 15. In the embodiment illustrated in FIG. 15, the imaging system 1400 is packaged on a platform 1510 and collects data from a field of view 1525 encompassing the scene 1450, shown in FIG. 14. The imaging system 1400 transmits the laser signal 1415, as represented by the arrow 1565, through the field of view 1525. The platform 1510 may be, for example, a reconnaissance drone or a flying submunition in the illustrated embodiment. In alternative embodiments, the platform 1510 may be a ground vehicle, or a watercraft. The nature of the platform 1510 in any given implementation is immaterial.

More technically, the LADAR transceiver 1500 transmits the laser signal 1415 to scan a geographical area called a “scan pattern” 1520. Each scan pattern 1520 is generated by scanning elevationally, or vertically, several times while scanning azimuthally, or horizontally, once within the field of view 1525 for the platform 1510. FIG. 15 illustrates a single elevational scan 1530 during the azimuthal scan 1540 for one scan pattern 1520. Thus, each scan pattern 1520 is defined by a plurality of elevational scans 1550 such as the elevational scan 1530 and the azimuthal scan 1540. The principal difference between the successive scan patterns 1520 is the location of the platform 1510 at the start of the scanning process. An overlap 1560 between the scan patterns 1520 is determined by the velocity of the platform 1510. The velocity, depression angle of the sensor with respect to the horizon, and total azimuth scan angle of the LADAR platform 1510 determine the scan pattern 1520 on the ground. Note that, if the platform 1510 is relatively stationary, the overlap 1560 may be complete, or nearly complete.

The laser signal 1415 is typically a pulsed, split-beam laser signal. The imaging system 1400 produces a pulsed (i.e., non-continuous) single beam that is then split into several beamlets spaced apart from one another by a predetermined amount. Each pulse of the single beam is split, and so the laser signal 1415 transmitted during the elevational scan 1550 in FIG. 15 is actually, in the illustrated embodiment, a series of grouped beamlets. The imaging system 1400 aboard the platform 1510 transmits the laser signal 1415 while scanning elevationally 1550 and azimuthally 1540. The laser signal 1415 is continuously reflected back to the platform 1510, which receives the reflected laser signal.

Suitable mechanisms for use in generation and acquiring LADAR signals are disclosed in:
U.S. Pat. No. 5,200,606, entitled “Laser Radar Scanning System,” issued Apr. 6, 1993, to LTV Missiles and Electronics Group as assignee of the inventors Nicholas J. Krasutsky, et al; and
U.S. Pat. No. 5,224,109, entitled “Laser Radar Transceiver,” issued Jun. 29, 1993, to LTV Missiles and Electronics Group as assignee of the inventors Nicholas J. Krasutsky, et al.
   However, any suitable mechanism known to the art may be employed.

The imaging system 1400 of the illustrated embodiment employs the LADAR seeker head (“LASH”) more fully disclosed and claimed in the aforementioned U.S. Pat. No. 5,200,606. This particular LASH splits a single 0.2 mRad l/e² laser pulse into septets, or seven individual beamlets, with a laser beam divergence for each spot of 0.2 mRad with beam separations of 0.4 mRad. The optics package (not shown) of this LASH includes a fiber optical array (not shown) having a row of seven fibers spaced apart to collect the return light. The fibers have an acceptance angle of 0.3 mrad and a spacing between fibers that matches the 0.4 mRad far field beam separation. An elevation scanner (not shown) spreads the septets vertically by 0.4 mRad as it produces the vertical scan angle. The optical transceiver including the scanner is then scanned azimuthally to create a full scan raster.

Referring again to FIG. 15, the optics package aboard platform 1510 transmits the beamlets while scanning elevationally 1550 and azimuthally 1540. The scan pattern 1520 therefore comprises a series of successive elevational scans, or “nods,” 1530. The laser signal 1415 is continuously reflected back to the platform 1510, as indicated by the arrow 1570, which receives the reflected laser signal. The total return from each scan pattern 1520 is known as a “scan raster.” The reflected signal is then comprised of azimuthally spaced nods 1530.

The acquisition technique described above is what is known as a “scanned” illumination technique. Note that alternative embodiments may acquire the LADAR data set using an alternative technique known as “flash”, or “staring array”, illumination. However, in scanned illumination embodiments, auxiliary resolution enhancement techniques such as the one disclosed in U.S. Letters Patent No 5,898,483, entitled “Method for Increasing LADAR Resolution,” issued to Apr. 27, 1999, to Lockheed Martin Corporation as assignee of the inventors Edward Max Flowers, (“the 483 patent”) may be employed.

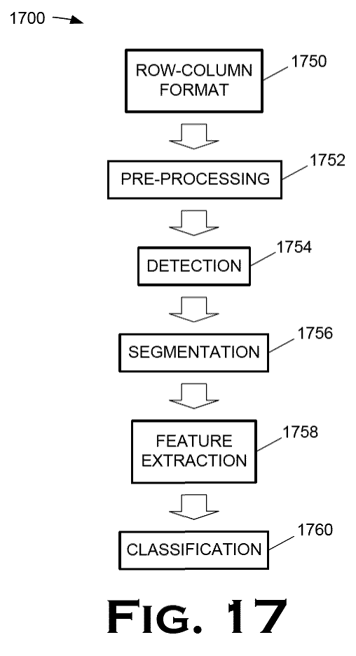

The nods 1530, shown in FIG. 15, are combined to create a nod pattern such as the nod pattern 1600 shown in FIG. 16. The nod pattern 1600 is comprised of a plurality of pixels 1602, only one of which is indicated. Each pixel 1602 corresponds to a single one of the reflected beamlets. The location of each pixel 1602 in the nod pattern 1600 represents an elevation angle and an azimuth angle between the object reflecting the beamlet and the platform 1510. Each pixel 1602 has associated with it a “range,” or distance from the reflecting surface, derived from the time of flight for the beamlet. Some embodiments may alternatively derive the range from the phase of the reflected signal. Each pixel 1602 also has associated therewith an energy level, or intensity, of the reflected beamlet. From the position of each pixel 1602 and its associated intensity, the position of the reflection point relative to the platform 1510 can be determined. Analysis of the positions of reflection points, as described below, can then yield information from which objects within the scene 1450, shown in FIG. 14, can be identified.

Each nod pattern 1600 from an azimuthal scan 1540 constitutes a “frame” of data for a LADAR image. The LADAR image may be a single such frame or a plurality of such frames, but will generally comprise a plurality of frames. Note that each frame includes a plurality of data points 1602, each data point representing an elevation angle, an azimuth angle, a range, and an intensity level. The data points 1602 are stored in a data structure 1480 resident in the data storage 1455, shown in FIG. 14, of the storage 1430 for the imaging system 1400.

FIG. 17 illustrates the handling of a set of LADAR data in an ATR system. The LADAR data is captured in row column format (at 1750) and processed by a processor or some other computing device such as a personal computer, a mini-computer, or other suitable computing device. This processing generally involves pre-processing (at 1752), detection (at 1754), segmentation (at 1756), feature extraction (at 1758), and classification (at 1760).

Generally, the pre-processing (at 1752) is directed to minimizing noise effects, such as identifying so-called intensity dropouts in the converted three-dimensional image, where the range value of the LADAR data is set to zero. Noise in the converted three-dimensional LADAR data introduced by low SNR conditions is processed so that performance of the overall system is not degraded. In this regard, the LADAR data is used so that absolute range measurement distortion is minimized, edge preservation is maximized, and preservation of texture step (that results from actual structure in objects being imaged) is maximized.

In general, detection (at 1754) identifies specific regions of interest in the pre-processed LADAR data. The detection (at 1754) uses range cluster scores as a measure to locate flat, vertical surfaces in an image. More specifically, a range cluster score is computed at each pixel to determine if the pixel lies on a flat, vertical surface. The flatness of a particular surface is determined by looking at how many pixels are within a given range in a small region of interest. The given range is defined by a threshold value that can be adjusted to vary performance. For example, if a computed range cluster score exceeds a specified threshold value, the corresponding pixel is marked as a detection. If a corresponding group of pixels meets a specified size criterion, the group of pixels is referred to as a region of interest. Regions of interest, for example those regions containing one or more targets, are determined and passed on for segmentation (at 1756).

Segmentation (at 1756) determines, for each detection of a target, which pixels in a region of interest belong to the detected target and which belong to the detected target's background. Segmentation (at 1756) identifies possible targets, for example, those whose connected pixels exceed a height threshold above the ground plane. More specifically, the segmentation (at 1756) separates target pixels from adjacent ground pixels and the pixels of nearby objects, such as bushes and trees.

Feature extraction (at 1758) provides information about a segmentation (at 1756) so that the target and its features in that segmentation can be classified. Features include, for example, orientation, length, width, height, radial features, turret features, and moments. The feature extraction (at 1758) also typically compensates for errors resulting from segmentation (at 1756) and other noise contamination. Feature extraction (at 1758) generally determines a target's three-dimensional orientation and size and a target's size. The feature extraction (at 1758) also distinguishes between targets and false alarms and between different classes of targets.

Classification (at 1760) classifies segmentations to contain particular targets, usually in a two-stage process. First, features such as length, width, height, height variance, height skew, height kurtosis, and radial measures are used to initially discard non-target segmentations. Classification (at 1760) includes matching the true target data to data stored in a target database. In the illustrated embodiment, the target database comprises a plurality of synthetic 3D models 1485, at least one of which is a synthetic synthetic 3D model generated as described above from imagery, in a model library 1490. Other data (not shown) in the target database, may include, for example, length, width, height, average height, hull height, and turret height. The classification (at 1760) is performed using known methods for table look-ups and comparisons. A variety of classification techniques are known to the art, and any suitable classification technique may be employed. One such technique is disclosed in U.S. Letters Patent 5,893,085, entitled “Dynamic Fuzzy Logic Process for Identifying Objects in Three-Dimensional Data,” and issued Apr. 6, 1999, to Lockheed Martin Corporation as assignee of the inventors Ronald W. Phillips and James L. Nettles.

Some portions of the detailed descriptions herein are consequently presented in terms of a software implemented process involving symbolic representations of operations on data bits within a memory in a computing system or a computing device. These descriptions and representations are the means used by those in the art to most effectively convey the substance of their work to others skilled in the art. The process and operation require physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, pixels, voxels or the like.

It should be borne in mind, however, that all of these and similar terms are to be associated with the appropriate physical quantities and are merely convenient labels applied to these quantifies. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method for modeling an object in software, comprising:
generating a three-dimensional geometry of the object from a plurality of points obtained from a plurality of images of the object, the images having been acquired from a plurality of perspectives; and
generating a three-dimensional model from the three-dimensional geometry for integration into an object recognition system.

2. The method of claim 1, wherein generating the three-dimensional geometry includes generating the three-dimensional geometry of the object from a plurality of points obtained from a plurality of two-dimensional images of the object.

3. (canceled)

4. The method of claim 2, wherein generating the three-dimensional geometry includes:
selecting a plurality of points in each of the two-dimensional images;
calibrating the relationship between the images from selected points that are co-located in more than one of the two-dimensional images; and
mapping the selected points in the calibrated two-dimensional images into a three-dimensional space.

5-6. (canceled)

7. The method of claim 4, wherein mapping the selected points into the three-dimensional space includes:
defining the three-dimensional space from the calibrated relationships between the images; and
placing the selected points into the three-dimensional space using the co-located points as references between the images.

8-9. (canceled)

10. The method of claim 1, wherein generating the three-dimensional geometry includes generating a plurality of surface geometries for the object from three-dimensional data generated from the images.

11. The method of claim 10, wherein generating the surface geometries includes connecting the three-dimensional data to planar curves.

12-15. (canceled)

16. The method of claim 1, wherein generating the three-dimensional model from the three-dimensional geometry includes:
rotating the three-dimensional geometry; and
generating a plurality of synthetic signatures of the model from a plurality of perspectives at the three-dimensional geometry is rotated.

17. The method of claim 16, where generating the synthetic signatures comprises generating a plurality of synthetic LADAR signatures.

18. The method of claim 1, wherein the images comprise three-dimensional images.

19. The method of claim 1, wherein the images comprise two-dimensional images.

20. The method of claim 1, wherein the images comprise at least one of photographic images, laser radar images, synthetic aperture radar images, drawings, and infrared images.

21-22. (canceled)

23. The method of claim 1, wherein generating the three-dimensional model for integration into the object recognition system includes generating the three-dimensional model for integration into a target recognition system.

24. A program storage medium encoded with instructions that, when executed by a computer, perform a method for modeling an object in software, the method comprising:
generating a three-dimensional geometry of the object from a plurality of points obtained from a plurality of images of the object, the images having been acquired from a plurality of perspectives; and
generating a three-dimensional model from the three-dimensional geometry for integration into an object recognition system.

25. The program storage medium of claim 24, wherein generating the three-dimensional geometry in the encoded method includes generating the three-dimensional geometry of the object from a plurality of points obtained from a plurality of two-dimensional images of the object.

26. The program storage medium of claim 24, wherein generating the three-dimensional geometry in the encoded method includes generating a plurality of surface geometries for the object from three-dimensional data generated from the images.

27. The program storage medium of claim 24, wherein generating a three-dimensional geometry in the encoded method includes:
generating a preliminary three-dimensional geometry from object from the images to define a three-dimensional space; and
generating a final three-dimensional geometry from the images, the final three-dimensional geometry being defined within the three-dimensional space.

28. The program storage medium of claim 24, wherein generating the three-dimensional model from the three-dimensional geometry in the encoded method includes:
rotating the three-dimensional geometry; and
generating a plurality of synthetic signatures of the model from a plurality of perspectives at the three-dimensional geometry is rotated.

29. The program storage medium of claim 24, wherein the images comprise three-dimensional images.

30. The program storage medium of claim 24, wherein the images comprise two-dimensional images.

31. The program storage medium of claim 24, wherein the images comprise at least one of photographic images, laser radar images, synthetic aperture radar images, drawings, and infrared images.

32. The program storage medium of claim 24, wherein generating the three-dimensional model in the encoded method includes generating a three-dimensional model of LADAR returns from the object.

33. The program storage medium of claim 24, wherein generating the three-dimensional model for integration into the object recognition system in the encoded method includes generating the three-dimensional model for integration into a target recognition system.

34. A programmed computer, comprising:
a processor;
a bus system;
a storage with which the processor communicates over the bus system; and
a software application residing in the storage and capable of performing a method for modeling an object in software upon invocation by the processor, the method comprising:
generating a three-dimensional geometry of the object from a plurality of points obtained from a plurality of images of the object, the images having been acquired from a plurality of perspectives; and
generating a three-dimensional model from the three-dimensional geometry for integration into an object recognition system.

35. The computer of claim 34, wherein generating the three-dimensional geometry in the programmed method includes generating the three-dimensional geometry of the object from a plurality of points obtained from a plurality of two-dimensional images of the object.

36. The computer of claim 34, wherein generating the three-dimensional geometry in the programmed method includes generating a plurality of surface geometries for the object from three-dimensional data generated from the images.

37. The computer of claim 34, wherein generating a three-dimensional geometry in the programmed method includes:
generating a preliminary three-dimensional geometry from object from the images to define a three-dimensional space; and
generating a final three-dimensional geometry from the images, the final three-dimensional geometry being defined within the three-dimensional space.

38. The computer of claim 34, wherein generating the three-dimensional model from the three-dimensional geometry in the programmed method includes:
rotating the three-dimensional geometry; and
generating a plurality of synthetic signatures of the model from a plurality of perspectives at the three-dimensional geometry is rotated.

39. The computer of claim 34, wherein the images comprise three-dimensional images.

40. The computer of claim 34, wherein the images comprise two-dimensional images.

41. The computer of claim 34, wherein the images comprise at least one of photographic images, laser radar images, synthetic aperture radar images, drawings, and infrared images.

42. The computer of claim 34, wherein generating the three-dimensional model in the programmed method includes generating a three-dimensional model of LADAR returns from the object.

43. The computer of claim 34, wherein generating the three-dimensional model for integration into the object recognition system in the programmed method includes generating the three-dimensional model for integration into a target recognition system.

44. A method for modeling an object in software, comprising:
creating a three-dimensional geometry of the object from a plurality of two-dimensional images of the object, the images having been acquired from a plurality of perspectives; and
generating a three-dimensional model from the three-dimensional geometry for integration into an object recognition system.

45. The method of claim 44, wherein creating the three-dimensional geometry includes generating a set of three-dimensional data from a set of two-dimensional data representing the two-dimensional images.

46. The method of claim 45, wherein generating the set of three-dimensional data includes:
selecting a plurality of points in each of the two-dimensional images;
calibrating the relationship between the images from selected points that are co-located in more than one of the two-dimensional images; and
mapping the selected points in the calibrated two-dimensional images into a three-dimensional space.

47-51. (canceled)

52. The method of claim 44, wherein creating the three-dimensional geometry includes generating a plurality of surface geometries for the object from three-dimensional data generated from the images.

53. The method of claim 52, wherein generating the surface geometries includes connecting the three-dimensional data to planar curves.

54. The method of claim 44, wherein creating the three-dimensional geometry includes:
generating a preliminary three-dimensional geometry from object from the images to define a three-dimensional space; and
generating a final three-dimensional geometry from the images, the final three-dimensional geometry being defined within the three-dimensional space.

55. The method of claim 54, wherein generating the preliminary three-dimensional geometry includes:
selecting a plurality of points in each of the two-dimensional images;
calibrating the relationship between the images from selected points that are co-located in more than one of the two-dimensional images; and
mapping the selected points in the calibrated two-dimensional images into the three-dimensional space.

56-57. (canceled)

58. The method of claim 44, wherein generating the three-dimensional model from the three-dimensional geometry includes:
rotating the three-dimensional geometry; and
generating a plurality of synthetic signatures of the model from a plurality of perspectives at the three-dimensional geometry is rotated.

59. The method of claim 58, where generating the synthetic signatures comprises generating a plurality of synthetic LADAR signatures.

60. The method of claim 44, wherein the two-dimensional images comprise at least one of photographic images, laser radar images, synthetic aperture radar images, drawings, and infrared images.

61. The method of claim 44, wherein generating the three-dimensional model includes generating a three-dimensional model of LADAR returns from the object.

62. The method of claim 61, wherein generating the three-dimensional model of the LADAR returns for integration into the object recognition system includes generating the three-dimensional model of the LADAR returns for integration into a target recognition system.

63. The method of claim 44, wherein generating the three-dimensional model for integration into the object recognition system includes generating the three-dimensional model for integration into a target recognition system.

64. A method for modeling an object in software, comprising:
generating a three-dimensional geometry of the object from a plurality of points obtained from a plurality of images of the object, the images having been acquired from a plurality of perspectives, including:
generating a preliminary three-dimensional geometry from object from the images to define a three-dimensional space; and
generating the three-dimensional geometry from the images, the three-dimensional geometry being defined within the three-dimensional space; and
generating a three-dimensional model from the three-dimensional geometry for integration into an object recognition system.

65. The method of claim 64, wherein generating the preliminary three-dimensional geometry includes:
selecting a plurality of points in each of the two-dimensional images;
calibrating the relationship between the images from selected points that are co-located in more than one of the two-dimensional images; and
mapping the selected points in the calibrated two-dimensional images into the three-dimensional space.

66. The method of claim 65, wherein mapping the selected points into the three-dimensional space includes:
defining the three-dimensional space from the calibrated relationships between the images; and
placing the selected points into the three-dimensional space using the co-located points as references between the images.

67. The method of claim 65, wherein generating the final three-dimensional geometry includes:
selecting a second plurality of points in each of the two-dimensional images; and
mapping the second plurality of selected points into the three-dimensional space.

68. The method of claim 64, wherein generating the three-dimensional model includes generating a three-dimensional model of LADAR returns from the object.

69. The method of claim 68, wherein generating the three-dimensional model of the LADAR returns for integration into the object recognition system includes generating the three-dimensional model of the LADAR returns for integration into a target recognition system.

70. A program storage medium encoded with instructions that, when executed by a computing device, perform a method for modeling an object in software, the method comprising:
generating a three-dimensional geometry of the object from a plurality of points obtained from a plurality of images of the object, the images having been acquired from a plurality of perspectives, including:
generating a preliminary three-dimensional geometry from object from the images to define a three-dimensional space; and
generating the three-dimensional geometry from the images, the three-dimensional geometry being defined within the three-dimensional space; and
generating a three-dimensional model from the three-dimensional geometry for integration into an object recognition system.

71. The program storage medium of claim 70, wherein generating the preliminary three-dimensional geometry in the method includes:
selecting a plurality of points in each of the two-dimensional images;
calibrating the relationship between the images from selected points that are co-located in more than one of the two-dimensional images; and
mapping the selected points in the calibrated two-dimensional images into the three-dimensional space.

72. The program storage medium of claim 70, wherein generating the three-dimensional model in the method includes generating a three-dimensional model of LADAR returns from the object.

73. A programmed computer, comprising:
a processor;
a bus system;
a storage with which the processor communicates over the bus system; and
a software application residing in the storage and capable of performing a method for modeling an object in software upon invocation by the processor, the method comprising:
generating a three-dimensional geometry of the object from a plurality of points obtained from a plurality of images of the object, the images having been acquired from a plurality of perspectives, including:
generating a preliminary three-dimensional geometry from object from the images to define a three-dimensional space; and
generating the three-dimensional geometry from the images, the three-dimensional geometry being defined within the three-dimensional space; and
generating a three-dimensional model from the three-dimensional geometry for integration into an object recognition system.

74. The programmed computer of claim 73, wherein generating the preliminary three-dimensional geometry in the method includes:
selecting a plurality of points in each of the two-dimensional images;
calibrating the relationship between the images from selected points that are co-located in more than one of the two-dimensional images; and
mapping the selected points in the calibrated two-dimensional images into the three-dimensional space.

75. The programmed computer of claim 73, wherein generating the three-dimensional model in the method includes generating a three-dimensional model of LADAR returns from the object.

76. A method for modeling an object in software, comprising:
generating a three-dimensional geometry of the object from a plurality of points obtained from a plurality of images of the object, the images having been acquired from a plurality of perspectives; and
generating a three-dimensional model of a LADAR return from the three-dimensional geometry for integration into an object recognition system.

77. The method of claim 76, wherein generating the three-dimensional model of the LADAR returns for integration into the object recognition system includes generating the three-dimensional model of the LADAR returns for integration into a target recognition system.

78. The method of claim 76, wherein generating the three-dimensional model from the three-dimensional geometry includes:
rotating the three-dimensional geometry; and
generating a plurality of synthetic signatures of the model from a plurality of perspectives at the three-dimensional geometry is rotated.

79. A program storage medium encoded with instructions that, when executed by a computing device, perform a method for modeling an object in software, the method comprising:
generating a three-dimensional geometry of the object from a plurality of points obtained from a plurality of images of the object, the images having been acquired from a plurality of perspectives; and
generating a three-dimensional model of a LADAR return from the three-dimensional geometry for integration into an object recognition system.

80. The program storage medium of claim 79, wherein generating the three-dimensional model of the LADAR returns for integration into the object recognition system in the method includes generating the three-dimensional model of the LADAR returns for integration into a target recognition system.

81. The program storage medium of claim 79, wherein generating the three-dimensional model from the three-dimensional geometry in the method includes:
rotating the three-dimensional geometry; and
generating a plurality of synthetic signatures of the model from a plurality of perspectives at the three-dimensional geometry is rotated.

82. A programmed computer, comprising:
a processor;
a bus system;
a storage with which the processor communicates over the bus system; and
a software application residing in the storage and capable of performing a method for modeling an object in software upon invocation by the processor, the method comprising:
generating a three-dimensional geometry of the object from a plurality of points obtained from a plurality of images of the object, the images having been acquired from a plurality of perspectives, including:
generating a three-dimensional model of a LADAR return from the three-dimensional geometry for integration into an object recognition system.

83. The programmed computer of claim 82, wherein generating the three-dimensional model of the LADAR returns for integration into the object recognition system in the method includes generating the three-dimensional model of the LADAR returns for integration into a target recognition system.

84. The programmed computer of claim 82, wherein generating the three-dimensional model from the three-dimensional geometry in the method includes:
rotating the three-dimensional geometry; and
generating a plurality of synthetic signatures of the model from a plurality of perspectives at the three-dimensional geometry is rotated.
